(19) United States
(12) Patent Application Publication
(10) Pub. No.: US 2024/0425073 A1
(43) Pub. Date: Dec. 26, 2024

(54) METHODS AND SYSTEMS FOR MODEL BASED OPTIMAL LONGITUDINAL PATH PLANNER

(71) Applicant: TORC Robotics, Inc., Blacksburg, VA (US)

(72) Inventor: Justin YURKANIN, Blacksburg, VA (US)

(73) Assignee: TORC Robotics, Inc., Blacksburg, VA (US)

(21) Appl. No.: 18/339,771

(22) Filed: Jun. 22, 2023

(51) Int. Cl. B60W 60/00

(52) U.S. Cl. CPC B60W 60/001; B60W 2520/10; B60W 2720/106

(57) ABSTRACT

A method may include obtaining, from a kinematic vehicle model including a differential equation, by one or more processors associated with an autonomous vehicle, one or more candidate trajectories that satisfy one or more constraints relating to movement of the vehicle. The method may include iteratively updating, by the one or more processors, a score of each of the one or more candidate trajectories. The method may include determining, by the one or more processors among the one or more candidate trajectories, a target trajectory having a score that is greater than a threshold. The method may include executing, by the one or more processors, the target trajectory to cause the vehicle to move in the candidate trajectory.

### TECHNICAL FIELD

The present disclosure relates generally to the generation and optimization of paths or trajectories used by autonomous vehicles.

### BACKGROUND

Autonomous vehicles generally requires a robust and stable motion control for navigation. For example, a longitudinal motion control is responsible for regulating a vehicle's cruise velocity in a forward direction. An autonomous vehicle may perform a path planning to find a longitudinal path or trajectory in which the vehicle can follow a navigation route without rear ending a vehicle ahead of it and obeying the traffic regulation. Finding an optimal path may require sampling/checking different paths extensively and pick a best path among them, which can be time-consuming and computationally expensive. As the dimension and size of the problem (e.g., number of different parameters/constraints) increase, the path planning may need to check more paths, which may become computationally intense and infeasible and may even create undesirable delays when the vehicle is driving.

### SUMMARY

The systems and methods of the present disclosure attempts to solve the problems set forth above and/or other problems in the art. For the aforementioned reasons, there is a need for a system and method for more efficiently eliminating inefficiencies and other technical shortcomings created by conventional longitudinal path planning techniques. The methods and systems described herein allow an autonomous vehicle to more efficiently find an optimal longitudinal path or trajectory that satisfies a number of constraints (e.g., constraints relating to time-velocity, time-distance, distance-velocity).

In one embodiment, a method may include obtaining, from a kinematic vehicle model including a differential equation, by one or more processors associated with an autonomous vehicle, one or more candidate trajectories that satisfy one or more constraints relating to movement of the vehicle. The method may include iteratively updating, by the one or more processors, a score of each of the one or more candidate trajectories. The method may include determining, by the one or more processors among the one or more candidate trajectories, a target trajectory having a score that is greater than a threshold. The method may include executing, by the one or more processors, the target trajectory to cause the vehicle to move in the candidate trajectory.

In another embodiment, a system may include one or more processors and a non-transitory computer readable medium containing instructions that are executed by the one or more processors associated with an autonomous vehicle. The instructions may cause the one or more processors to obtain, from a kinematic vehicle model including a differential equation, one or more candidate trajectories that satisfy one or more constraints relating to movement of the vehicle. The instructions may cause the one or more processors to iteratively update a score of each of the one or more candidate trajectories. The instructions may cause the one or more processors to determine, among the one or more candidate trajectories, a target trajectory having a score that is greater than a threshold. The instructions may cause the one or more processors to execute the target trajectory to cause the vehicle to move in the candidate trajectory.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a system diagram of an autonomous vehicle control system, according to an embodiment.

FIG. 2 illustrates a block diagram of generating a path (trajectory) using a path generation and optimization system, according to an embodiment.

FIGS. 3A and 3B illustrate diagrams of paths (trajectories) generated by a path generation and optimization system, according to an embodiment.

FIG. 4 depicts a flowchart of a method executed in a path generation and optimization system, according to an embodiment.

### DETAILED DESCRIPTION

The following detailed description describes various features and functions of the disclosed systems and methods with reference to the accompanying figures. In the figures, similar components are identified using similar symbols, unless otherwise contextually dictated. The exemplary system(s) and method(s) described herein are not limiting and it may be readily understood that certain aspects of the disclosed systems and methods can be variously arranged and combined, all of which arrangements and combinations are contemplated by this disclosure.

Embodiments herein generally describe a path generation and optimization system for an autonomous vehicle and methods of use thereof. According to some embodiments, a method may include obtaining, from a kinematic vehicle model, by one or more processors associated with an autonomous vehicle, one or more candidate trajectories that satisfy one or more constraints relating to movement of the vehicle. The method may include iteratively updating, by the one or more processors, a score of each of the one or more candidate trajectories. The method may include determining, by the one or more processors among the one or more candidate trajectories, a target trajectory having a score that is greater than a threshold. The method may include executing, by the one or more processors, the target trajectory to cause the vehicle to move in the candidate trajectory.

Finding an optimal path generally requires sampling/checking different paths extensively and pick a best path among them, which can be time-consuming and computationally expensive. As the dimension and size of the problem (e.g., number of different parameters/constraints) increase, the path planning may need to check more paths, which may become computationally intense and infeasible and may even create undesirable delays when the vehicle is driving.

To solve this problem, according to certain aspects, embodiments in the present disclosure relate to generating and optimizing longitudinal paths or trajectories that satisfy constraints in the form of distance-time, velocity-time, and/or velocity-distance profiles, for example. In some embodiments, a system (e.g., a longitudinal path generation and optimization system) may generate and optimize longitudinal paths or trajectories based on a vehicle model (e.g., kinematic vehicle model). Longitudinal paths or trajectories may relate to vehicle forward motions including stopping.

The system may include a path planner that can perform a model-based longitudinal path optimization. In some embodiments, the path planner may ultimately generate a target path or trajectory for a vehicle which specifies/represents a change in distance, velocity, and/or acceleration over time, and send the generated target path/trajectory to a motion controller to control the vehicle to move forward and/or stop if necessary. In some embodiments, the path planner may include a longitudinal vehicle model (e.g., kinematic vehicle model), a nonlinear (path) optimizer, a differentiable simulator, and/or a path scoring function/system. In some embodiments, the nonlinear path optimizer may include a differentiable simulator, and/or a path scoring function/system. In some embodiments, the path planner may receive input data from one or more sensors (e.g., cameras, radar, light detection and ranging (LIDAR) sensors) and maps (e.g., high-definition (HD) maps for navigation), generate/consolidate constraints and/or objectives, and send the constraints and/or objectives to the path optimizer. The path optimizer may generate and optimize paths (trajectories), select/pick a target path which specifies a desired acceleration over time, for example, and send out the target path to a motion controller.

In some embodiments, the longitudinal vehicle model may produce candidate trajectories that can realistically represent vehicle dynamics (e.g., the motion of a vehicle generated by a steering action, through which the vehicle is capable of independent motion), be within acceleration limits, and/or smooth. In some embodiments, the longitudinal vehicle model may be a kinematic vehicle model that simulates a simplified car-like vehicle dynamics, for example, an Ackermann kinematic model. In some embodiments, the longitudinal vehicle model may integrate a simple kinematic model to create one or more paths or trajectories. The longitudinal vehicle model may have one or more differential equations to simulate a vehicle traveling a forward path. In some embodiments, using the longitudinal vehicle model, the path planner may find one or more paths that navigate one or more constraints and also satisfy other objectives. For example, the objectives may include driving realistically (e.g., within the vehicle's performance limit), driving with comfortable acceleration, driving with comfortable jerk (e.g., acceleration over time), being safe, avoiding target objects, etc. In some embodiments, one or more differential equations may be numerically integrated over time such that the vehicle's forward motions can be simulated in time using differentiable simulation techniques. In some embodiments, the longitudinal vehicle model may generate an optimized output (e.g., candidate paths/trajectories) using a differentiable simulation technique.

In some embodiments, the one or more constraints may include information in the form of constraints over time. The one or more constraints may include one or more physical constraints (e.g., a detected obstacle ahead of the vehicle), distance-time constraints (e.g., moving forward in x meters in y seconds), velocity-time constraints (e.g., having a particular velocity in y seconds), and/or velocity-distance constraints (e.g., having a particular velocity after moving forward in x meters). In some embodiments, the path planner may include a constraint generator configured to generate one or more constraints based on sensor data (e.g., from one or more sensors such as cameras, radars, and/or LIDARs) and/or map data (e.g., from HD maps) because such constraints may vary depending road or traffic conditions. In some embodiments, the sensor data and/or map data may be stored in a server and remotely accessed by one or more processors of the vehicle. In some embodiments, the sensor data may be stored in a memory/storage in the vehicle. In some embodiments, the constraint generator may generate the one or more constraints based on pre-processed sensor data (e.g., average values over predetermined periods). The path planner may generate/find one or more candidate paths (trajectories) that navigate the constraints and also satisfies other objectives like driving with comfortable acceleration, driving with comfortable jerk, and so on. In some embodiments, the path planner may include an objective generator configured to generate one or more objective (or objective functions) based on sensor data and/or map data because such objectives may vary depending road or traffic conditions.

In some embodiments, the nonlinear path optimizer may include a differentiable simulator that can perform a differentiable simulation using a longitudinal vehicle model. In some embodiments, the differentiable simulator may compute first-order derivative information and/or second-order derivative information using differentiable simulation techniques so that the path optimizer can benefit from the first-order and second-order derivative information. For example, the differentiable simulator can perform a first order optimization on a longitudinal vehicle model to compute the gradient of the control of the acceleration over time (as described in the longitudinal vehicle model) with respect to one or more objectives (e.g., driving with comfortable acceleration, driving with comfortable jerk, and so on), and find an optimal path (e.g., a local minimum of a differentiable function in the vehicle model) using a gradient decent optimization technique (or first-order iterative optimization technique). The differentiable simulator may compute the gradient, e.g., the derivative of the controls of the accelerations, at each different time step along an acceleration time curve, instead of computing the derivative of each one of those accelerations, with respect to an objective function for minimizing the objective function. In some embodiments, the optimal path may be in the form of jerk (derivative acceleration over time), acceleration over time, or distance over time. In some embodiments, the differentiable simulator may use auto-differentiation (e.g., auto-differentiation library in C++) to optimize one or more trajectories with respect to min-max bounds.

In some embodiments, the path optimizer may receive one or more constraints and one or more objectives and find forward motion attributes that satisfy the constraints and the objectives. The forward motion attributes may define a path/trajectory. For example, jerk (derivative acceleration with respect to time) as a forward motion attribute may define a path/trajectory of a vehicle. In some embodiments, the path optimizer can create longer paths or path plans (e.g., at least 10 seconds long) over time because the paths can be solved/found/obtained faster than a conventional scheme using gradients and differentiable simulation techniques.

In some embodiments, the path planner (or the path optimizer) may include a path scoring system (or path scoring function) that is tuned/adjusted to obtain a path/trajectory with improved performance. In some embodiments, upon the path optimizer generating one or more candidate paths (each representing a change/profile in distance, velocity, and/or acceleration over time, for example), the path scoring system may score each of the candidate paths based on how well each candidate path satisfies constraints, how poorly each candidate path fails objectives (e.g., how aggressively each candidate path can drive), and/or how well each candidate path satisfies objectives (e.g., how safely each candidate path can drive).

In some embodiments, the path scoring system may score each candidate path using a reward function that includes variables representing penalties and/or rewards. In some embodiments, the path scoring system may generate and/or adjust the reward function based on one or more constraints generated by the constraint generator and/or one or more objectives generated by the objective generator. The reward function may be used to give a reward or a penalty. For example, for a position (distance)-time constraint (e.g., a particular position at a particular time), the reward function may award a penalty to a candidate path if the path would cause the vehicle to exceed (pass), or fall short of, the particular position at the particular time. For a velocity-time constraint (e.g., speed limit of the road), the reward function may award a penalty to a candidate path if the path would cause the vehicle to exceed, or deviate too far from, the speed limit. The reward function may be tuned/adjusted (e.g., heuristic tuning) to balance between different constraints/objectives (e.g., giving different weights to different variables). For example, the reward function can be adjusted such that stopping at a stop line is more important than exceeding a speed limit.

In some embodiments, the path optimizer (or the path scoring system) may iteratively update a candidate path/trajectory to maximize the score of the candidate path/trajectory (using the reward function). Upon assigning/generating a score for each candidate path, the path scoring system may determine whether the current score of each candidate path is greater than a threshold. In response to determining that the current score of each candidate path is smaller than or equal to the threshold, the path scoring system may update each candidate path (e.g., modifying the profile in distance, velocity, and/or acceleration over time) to increase the score based on the reward function. After updating each candidate path, the path scoring system may determine whether the updated score of each candidate path is greater than a threshold, and so on. In this manner, each candidate path may be iteratively updated to different paths such that the path scoring system can penalize the candidate path when the constraints are ignored or not satisfied, in a manner that the candidate path is not equally penalized for each constraint/objective because there are constraints/objectives more important than other constraints/objectives.

In response to determining that the current score of a candidate path is greater than the threshold, the path scoring system may accept/detect/determine the candidate path as a target path/trajectory. In some embodiments, the path scoring system may send the target path/trajectory to a motion controller so that the motion controller can execute the target path/trajectory as accurately as possible. In some embodiments, the path planner may produce a new target trajectory at a quick rate (e.g., 10 Hz) in order to react quickly to changes in the environment. Additionally, the target trajectories may be long enough (e.g., at least 10 seconds) to intelligently consider obstacles and environmental conditions well ahead of the vehicle.

In some embodiments, a system may include one or more processors and a non-transitory computer readable medium containing instructions that are executed by the one or more processors associated with an autonomous vehicle. The instructions may cause the one or more processors to obtain, from a kinematic vehicle model, one or more candidate trajectories that satisfy one or more constraints relating to movement of the vehicle. The instructions may cause the one or more processors to iteratively update a score of each of the one or more candidate trajectories. The instructions may cause the one or more processors to determine, among the one or more candidate trajectories, a target trajectory having a score that is greater than a threshold. The instructions may cause the one or more processors to execute the target trajectory to cause the vehicle to move in the candidate trajectory.

In some embodiments, each of the one or more candidate trajectories may be a longitudinal trajectory for a predetermined duration of time. In some embodiments, the predetermined duration of time may be greater than or equal to 10 seconds. In some embodiments, each of the one or more constraints may relate to at least one of (1) distance and time, (2) velocity and time, or (3) velocity and distance.

In some embodiments, in obtaining the one or more candidate trajectories, the instructions may cause the one or more processors to perform a differentiable simulation on the differential equation. In some embodiments, in obtaining the one or more candidate trajectories, the instructions may cause the one or more processors to perform a first order optimization with respect to the differential equation. The differential equation may relate to a control of an acceleration of the vehicle.

In some embodiments, in iteratively updating the score of each candidate trajectory, the instructions may cause the one or more processors to update the score of each candidate trajectory based on a reward function. In some embodiments, in iteratively updating the score of each candidate trajectory, the instructions may cause the one or more processors to determine the score of each candidate trajectory based on how well each candidate trajectory satisfies the one or more constraints. In some embodiments, in iteratively updating the score of each candidate trajectory, the instructions may cause the one or more processors to determine the score of each candidate trajectory based on how aggressively each candidate trajectory drives the vehicle.

Embodiments in the present disclosure have at least the following advantages and benefits. First, embodiments in the present disclosure can provide useful techniques for obtaining target path/trajectories that are long enough (e.g., at least 10 seconds) using a nonlinear optimization to intelligently and smoothly consider obstacles and environmental conditions well ahead of the vehicle.

Second, embodiments in the present disclosure can provide useful techniques for more efficiently optimizing the path planning thereby reducing undesirable delays when the vehicle is driving. For example, the path planner may perform a first-order optimization using the gradient with respect to a kinematic vehicle model, allowing the gradient to converge faster to an optimal value. In this manner, the optimization can be quickly performed in a vehicle in real time, thereby generating a longer target path/trajectory compared to when the optimization is performed in a remote server or a cloud system.

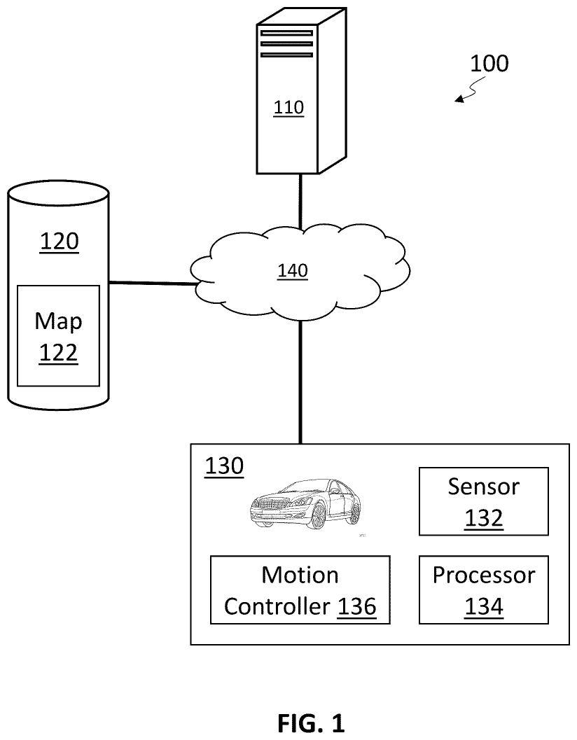

FIG. 1 is a non-limiting example of components of an autonomous vehicle control system 100 in which a server 110 operates. The server 110 may utilize features described in FIG. 1 to generate and/or revise one or more maps (e.g., HD maps 122) using one or more sensors of an autonomous vehicle 130. The system 100 is not confined to the components described herein and may include additional or other components not shown for brevity, which are to be considered within the scope of the embodiments described herein.

The features depicted in FIG. 1 may be connected through a network 140. The examples of the network 140 may include, but are not limited to, private or public LAN, WLAN, MAN, WAN, and the Internet. The network 140 may include both wired and wireless communications according to one or more standards and/or via one or more transport mediums.

The communication over the network 140 may be performed in accordance with various communication protocols such as Transmission Control Protocol and Internet Protocol (TCP/IP), User Datagram Protocol (UDP), and IEEE communication protocols. In one example, the network 140 may include wireless communications according to Bluetooth specification sets or another standard or proprietary wireless communication protocol. In another example, the network 140 may include communications over a cellular network, including, e.g., a GSM (Global System for Mobile Communications), CDMA (Code Division Multiple Access), and/or EDGE (Enhanced Data for Global Evolution) network.

The server 110 may be any computing device comprising a processor and non-transitory, machine-readable storage capable of executing the various tasks and processes described herein. The server 110 may employ various processors such as a central processing unit (CPU) and graphics-processing unit (GPU), among others. Non-limiting examples of such computing devices may include workstation computers, laptop computers, server computers, and the like. While the system 100 includes a single server 110, the server 110 may include any number of computing devices operating in a distributed computing environment, such as a cloud environment.

The server 110 may be associated with an autonomy system that uses various methods to provide autonomous vehicle navigation for one or more autonomous vehicles 130. In some embodiments, the autonomous vehicles may use an HD map that is stored in a data repository, such as a database 120. The database 120 may be any data repository (e.g., relational database) configured to store data, such as the HD map 122. The database 120 may be in communication with the server 110, such that the data records are stored within the database 120. As used herein an HD map refers to any map that can be used by an autonomous vehicle for navigational purposes.

The system 100 may also include an autonomous vehicle 130. The autonomous vehicle 130 may include one or more sensors (e.g., represented by the sensor 132) that can sense data relating to the vehicle's surrounding environment (e.g., lane markings, traffic lights, and/or static/dynamic objects within the surrounding environment). The sensor 132 may include at least one of cameras, radars, and/or LIDARs.

The autonomous vehicle 130 may include a processor 134 that can communicate with the sensor 132 and the server 110. The processor 134 may use a Global Navigation Satellite System (GNSS) to identify the location of the vehicle and/or objects or lane markings within the vehicle's surrounding environment. For instance, the processor 134 may use any network of satellites that transmit signals to GPS (Global Positioning System) receivers of the autonomous vehicle 130 and/or the processor 134. The processor 134 may use these signals to determine the receiver's precise location, velocity, and time. The processor 134 may use a communication module configured to communicate with the server 110. For instance, the processor 134 may include antennas or any other wired/wireless communication protocol or apparatus to communicate with the server 110.

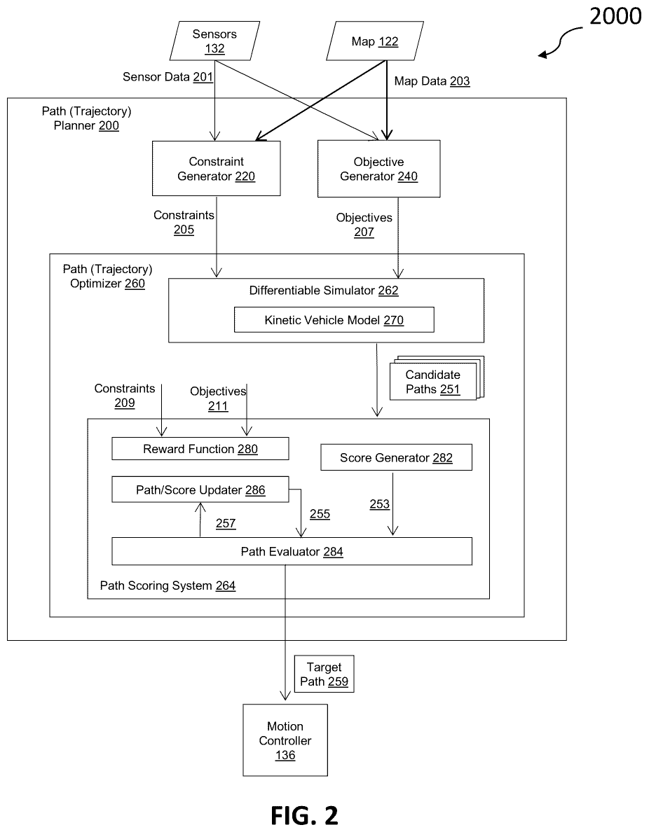

The processor 134 may generate and/or optimize longitudinal paths or trajectories that satisfy constraints in the form of distance-time, velocity-time, and/or velocity-distance profiles, for example. The processor 134 may generate and/or optimize longitudinal paths or trajectories based on a vehicle model (e.g., kinematic vehicle model). The processor 134 may perform a model-based longitudinal path optimization. Details of the model-based longitudinal path optimization will be described with reference to FIG. 2 to FIG. 4.

The autonomous vehicle 130 may include a motion controller 136 that can control the longitudinal, lateral and vertical dynamics of the vehicle 130. The motion controller 136 may perform a direction control, a powertrain control, a brake control and/or a damper control. The motion controller 136 may control the optimal driving strategy and/or the optimal interaction of all actuators in the vehicle 130. In some embodiments, the motion controller 136 may be implemented in an electronic control unit (ECU). In some embodiments, the motion controller 136 may be a software module, which may be executed by one or more processors.

FIG. 2 illustrates a block diagram of generating a path (trajectory) using a path generation and optimization system 2000, according to an embodiment. In some embodiments, path generation and optimization system 2000 may include one or more sensors 132, map 122 (e.g., HD map), a path planner 200, and/or a motion controller 136. The path planner 200 may be a software module, which may be executed by one or more processors (e.g., processor 134 in FIG. 1). The path generation and optimization system 2000 may generate and/or optimize longitudinal paths or trajectories that satisfy constraints in the form of distance-time, velocity-time, and/or velocity-distance profiles, for example. In some embodiments, the system 2000 may generate and optimize longitudinal paths or trajectories based on a vehicle model (e.g., kinematic vehicle model). Longitudinal paths or trajectories may relate to vehicle forward motions including stopping.

The path planner 200 can perform a model-based longitudinal path optimization. In some embodiments, the path planner 200 may ultimately generate a target path or trajectory 259 for a vehicle (e.g., vehicle 130 in FIG. 1) which specifies/represents a change in distance, velocity, and/or acceleration over time, and send the generated target path/trajectory 259 to the motion controller 136 to control the vehicle to move forward and/or stop if necessary. In some embodiments, the path planner 200 may include a constraint generator 220, an objective generator 240, a longitudinal vehicle model (e.g., kinematic vehicle model 270), a nonlinear (path) optimizer 260, a differentiable simulator 262, and/or a path scoring function/system 264. In some embodiments, the nonlinear path optimizer 260 may include a differentiable simulator 262, and/or a path scoring function/system 264.

The path planner 200 may receive sensor data 201 from the one or more sensors 132 (e.g., cameras, radar, light detection and ranging (LIDAR) sensors), and map data 203 from maps (e.g., HD maps for navigation from the server 110 or database 120). The path planner 200 may generate/consolidate constraints 205 and/or objectives 207, and send the constraints 205 and/or objectives 207 to the path optimizer 260. The path optimizer 260 may generate and optimize paths (trajectories), select/pick a target path 259 which specifies a desired acceleration over time, for example, and send out the target path 259 to the motion controller 136.

The longitudinal vehicle model 270 may produce candidate trajectories 251 that can realistically represent vehicle dynamics (e.g., the motion of a vehicle generated by a steering action, through which the vehicle is capable of independent motion), be within acceleration limits, and/or smooth. The longitudinal vehicle model 270 may be a kinematic vehicle model that simulates a simplified car-like vehicle dynamics, for example, an Ackermann kinematic model. The longitudinal vehicle model 270 may integrate a simple kinematic model to create one or more paths or trajectories. The longitudinal vehicle model 270 may have one or more differential equations to simulate a vehicle traveling a forward path. Using the longitudinal vehicle model 270, the path planner 200 may find one or more paths that navigate one or more constraints 205 and also satisfy other objectives 207. For example, the objectives 207 may include driving realistically (e.g., within the vehicle's performance limit), driving with comfortable acceleration, driving with comfortable jerk (e.g., acceleration over time), being safe, avoiding target objects, etc. One or more differential equations in the longitudinal vehicle model 270 may be numerically integrated over time such that the vehicle's forward motions can be simulated in time using differentiable simulation techniques. The longitudinal vehicle model 270 may generate an optimized output (e.g., candidate paths/trajectories 251) using a differentiable simulation technique.

The one or more constraints 205 may include information in the form of constraints over time. The one or more constraints 205 may include one or more physical constraints (e.g., a detected obstacle ahead of the vehicle), distance-time constraints (e.g., moving forward in x meters in y seconds), velocity-time constraints (e.g., having a particular velocity in y seconds), and/or velocity-distance constraints (e.g., having a particular velocity after moving forward in x meters). The constraint generator 220 may generate one or more constraints 205 based on sensor data 201 (e.g., from one or more sensors such as cameras, radars, and/or LIDARs) and/or map data 203 (e.g., from HD maps) because such constraints may vary depending road or traffic conditions. The sensor data 201 and/or map data 203 may be stored in a server or a database and remotely accessed by one or more processors of the vehicle (e.g., processor 134). In some embodiments, the sensor data 201 may be stored in a memory/storage in the vehicle. The constraint generator 220 may generate the one or more constraints 205 based on pre-processed sensor data (e.g., average values over predetermined periods). The path planner 200 may generate/find one or more candidate paths (trajectories) 251 that navigate the constraints 205 and also satisfies other objectives 207 like driving with comfortable acceleration, driving with comfortable jerk, and so on. The objective generator 240 may generate one or more objective 207 (or objective functions) based on sensor data 201 and/or map data 203 because such objectives may vary depending road or traffic conditions.

The nonlinear path optimizer 260 may include a differentiable simulator 262 that can perform a differentiable simulation using a longitudinal vehicle model 270. The differentiable simulator 262 may compute first-order derivative information and/or second-order derivative information using differentiable simulation techniques so that the path optimizer 260 can benefit from the first-order and second-order derivative information. For example, the differentiable simulator 262 can perform a first order optimization on a longitudinal vehicle model to compute the gradient of the control of the acceleration over time (as described in the longitudinal vehicle model) with respect to one or more objectives 207 (e.g., driving with comfortable acceleration, driving with comfortable jerk. safe on the road, and so on), and find an optimal path (e.g., a local minimum of a differentiable function in the vehicle model) using a gradient decent optimization technique (or first-order iterative optimization technique). The differentiable simulator 262 may compute the gradient, e.g., the derivative of the controls of the accelerations, at each different time step along an acceleration time curve (instead of computing the derivative of each one of those accelerations), with respect to an objective function for minimizing the objective function. The optimal path may be in the form of jerk (derivative acceleration over time), acceleration over time, or distance over time. The differentiable simulator 262 may use auto-differentiation (e.g., auto-differentiation library in C++) to optimize one or more trajectories with respect to min-max bounds.

The path optimizer 260 may receive one or more constraints 205 and one or more objectives 207 and find forward motion attributes that satisfy the constraints and the objectives. The forward motion attributes may define a path/trajectory. For example, jerk (derivative acceleration with respect to time) as a forward motion attribute may define a path/trajectory of a vehicle. The path optimizer 260 can create longer paths or path plans (e.g., at least 10 seconds long) over time because the paths can be solved/found/obtained faster than a conventional scheme using gradients and differentiable simulation techniques.

The path planner 200 (or the path optimizer 260) may include a path scoring system (or path scoring function) 264 that is tuned/adjusted to obtain a path/trajectory with improved performance. The path scoring system 264 may include a score generator 282, a path/score updater 286, and/or a path evaluator 284. Upon the path optimizer 260 generating one or more candidate paths 251 (each representing a change/profile in distance, velocity, and/or acceleration over time, for example), the score generator 282 may score each of the candidate paths 251 based on how well each candidate path satisfies constraints, how poorly each candidate path fails objectives (e.g., how aggressively each candidate path can drive), and/or how well each candidate path satisfies objectives (e.g., how safely each candidate path can drive).

The path scoring system 264 may score each candidate path using a reward function 280 that includes variables representing penalties and/or rewards. The path scoring system 264 may generate and/or adjust the reward function 280 based on one or more constraints 209 generated by the constraint generator 220 and/or one or more objectives 211 generated by the objective generator 240. The reward function 280 may be used to give a reward or a penalty. For example, for a position (distance)-time constraint (e.g., a particular position at a particular time), the reward function 280 may award a penalty to a candidate path if the path would cause the vehicle to exceed (pass), or fall short of, the particular position at the particular time. For a velocity-time constraint (e.g., speed limit of the road), the reward function 280 may award a penalty to a candidate path if the path would cause the vehicle to exceed, or deviate too far from, the speed limit. The reward function 280 may be tuned/adjusted (e.g., heuristic tuning) to balance between different constraints/objectives (e.g., giving different weights to different variables). For example, the reward function 280 can be adjusted such that stopping at a stop line is more important than exceeding a speed limit.

The path scoring system 264 may iteratively update a candidate path/trajectory to maximize the score of the candidate path/trajectory (using the reward function 280). Upon assigning/generating a score for each candidate path 253, the path evaluator 284 may determine whether the current score of each candidate path 253 is greater than a threshold. In response to determining that the current score of each candidate path 257 is smaller than or equal to the threshold, the path/score updater 286 may update each candidate path 257 (e.g., modifying the profile in distance, velocity, and/or acceleration over time) to increase the score based on the reward function. After updating each candidate path, the path evaluator 284 may determine whether the updated score of each (updated) candidate path 255 is greater than a threshold, and so on. In this manner, each candidate path may be iteratively updated to different paths such that the path scoring system 264 can penalize the candidate path when the constraints are ignored or not satisfied, in a manner that the candidate path is not equally penalized for each constraint/objective because there are constraints/objectives more important than other constraints/objectives.

In response to determining that the current score of a candidate path is greater than the threshold, the path evaluator 284 (and path scoring system 264) may accept/detect/determine the candidate path as a target path/trajectory 259. The path evaluator 284 (and path scoring system 264) may send the target path/trajectory 259 to the motion controller 136 so that the motion controller 136 can execute the target path/trajectory 259 as accurately as possible. The path planner 200 may produce a new target trajectory at a quick rate (e.g., 10 Hz) in order to react quickly to changes in the environment. Additionally, the target trajectories may be long enough (e.g., at least 10 seconds) to intelligently consider obstacles and environmental conditions well ahead of the vehicle.

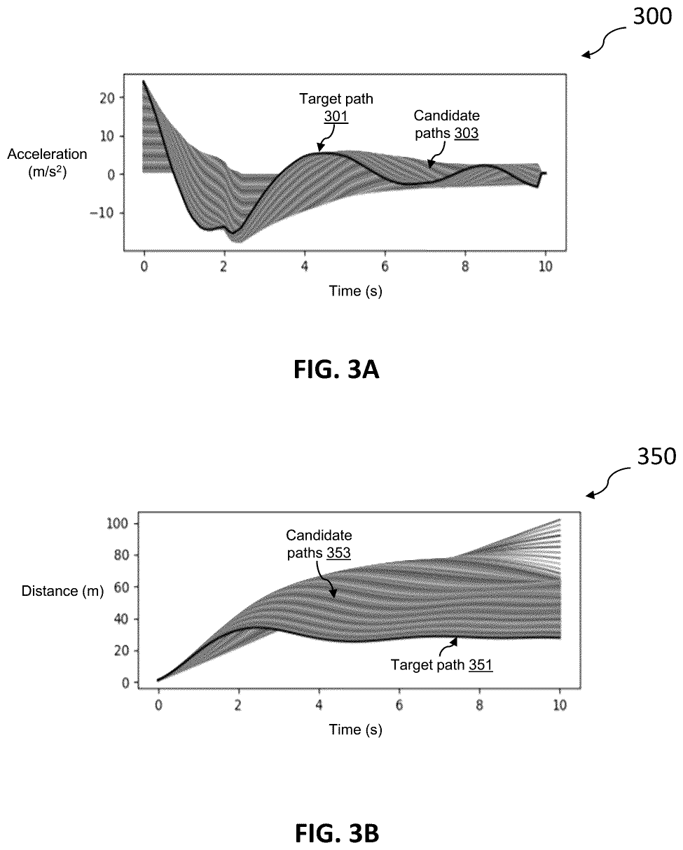

FIG. 3A and FIG. 3B illustrate diagrams of paths (trajectories) generated by a path generation and optimization system, according to an embodiment. FIG. 3A shows a diagram 300 of candidate paths 303 and a target path 301 in the form (profile) of acceleration (m/s²) over time (seconds). FIG. 3B shows a diagram 350 of candidate paths 353 and a target path 351 in the form (profile) of distance (meters) over time (seconds). The candidate paths 303, 353 may be generated based on a constraint such that the vehicle should stop for an intersection or a stop sign 30 meters ahead. As shown in FIG. 3A and FIG. 3B, as the optimizer (e.g., path optimizer 260) runs for multiple steps, the candidate paths 303, 353 converge to the target paths 301, 351. It is also shown that each of the candidate paths (and target paths) is long enough (e.g., 10 seconds) to intelligently consider obstacles and environmental conditions well ahead of the vehicle.

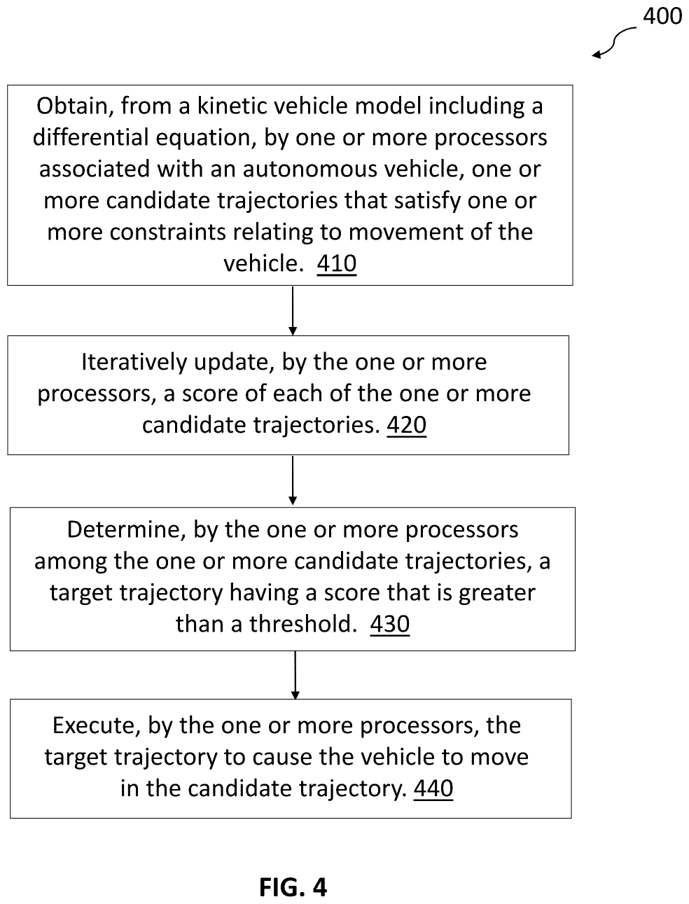

FIG. 4 depicts a flowchart of a method executed in a path generation and optimization system, according to an embodiment. The method 400 shown in FIG. 4 comprises execution steps 410-440. However, it should be appreciated that other embodiments may comprise additional or alternative execution steps, or may omit one or more steps altogether. It should also be appreciated that other embodiments may perform certain execution steps in a different order. Steps discussed herein may also be performed simultaneously or near-simultaneously.

FIG. 4 is described as being performed by one or more processors, such as the processor 134 or motion controller 136 as depicted in FIG. 1. However, in some embodiments, one or more of the steps may be performed by a different processor, server, or any other computing feature. For instance, one or more of the steps may be performed via a cloud-based service or another processor in communication with the one or more processors of the autonomous vehicle and/or its autonomy system. Although the steps are shown in FIG. 4 having a particular order, it is intended that the steps may be performed in any order. It is also intended that some of these steps may be optional.

Using the method 400, the processor may generate and/or optimize longitudinal paths or trajectories that satisfy constraints in the form of distance-time, velocity-time, and/or velocity-distance profiles, for example. Even though aspects of the present disclosure discusses optimization of longitudinal paths or trajectories, the method 400 is applicable to optimization of any paths/trajectories of moving objects, such as lateral or vertical paths/trajectories, and the like.

In an embodiment of the step 410, the one or more processors may obtain, from a kinematic vehicle model (e.g., kinetic vehicle model 270) including a differential equation, one or more candidate trajectories (e.g., candidate paths 251) that satisfy one or more constraints (e.g., constraints 205) relating to movement of the vehicle (e.g., constraints in the form of distance-time, velocity-time, and/or velocity-distance profiles).

In some embodiments, each of the one or more candidate trajectories may be a longitudinal trajectory for a predetermined duration of time. In some embodiments, the predetermined duration of time may be greater than or equal to 10 seconds (see FIG. 3A and FIG. 3B). In some embodiments, each of the one or more constraints relates to at least one of (1) distance and time, (2) velocity and time, or (3) velocity and distance. For example, the one or more constraints may include one or more physical constraints (e.g., a detected obstacle ahead of the vehicle), distance-time constraints (e.g., moving forward in x meters in y seconds), velocity-time constraints (e.g., having a particular velocity in y seconds), and/or velocity-distance constraints (e.g., having a particular velocity after moving forward in x meters).

In some embodiments, in obtaining the one or more candidate trajectories (e.g., candidate paths 251), the one or more processors may perform a differentiable simulation (e.g., by differentiable simulator 262) on the differential equation. In some embodiments, in obtaining the one or more candidate trajectories, the one or more processors may perform a first order optimization with respect to the differential equation. The differential equation may relate to a control of an acceleration of the vehicle.

In an embodiment of the step 420, the one or more processors may iteratively update a score of each of the one or more candidate trajectories (e.g., path scoring system 264 in FIG. 2). In some embodiments, in iteratively updating the score of each candidate trajectory, the one or more processors may update the score of each candidate trajectory based on a reward function (e.g., reward function 280). In some embodiments, in iteratively updating the score of each candidate trajectory, the one or more processors may determine the score of each candidate trajectory based on how well each candidate trajectory satisfies the one or more constraints. In some embodiments, in iteratively updating the score of each candidate trajectory, the one or more processors may determine the score of each candidate trajectory based on how aggressively each candidate trajectory drives the vehicle. For example, as shown in FIG. 2, the score generator 282 may score each of the candidate paths 251 based on how well each candidate path satisfies constraints, how poorly each candidate path fails objectives (e.g., how aggressively each candidate path can drive), and/or how well each candidate path satisfies objectives (e.g., how safely each candidate path can drive).

In an embodiment of the step 430, the one or more processors may determine, among the one or more candidate trajectories, a target trajectory (e.g., target path 259) having a score that is greater than a threshold.

In an embodiment of the step 440, the one or more processors may execute the target trajectory to cause the vehicle to move in the candidate trajectory. For example, as shown in FIG. 2, the path evaluator 284 (and path scoring system 264) may send the target path/trajectory 259 to the motion controller 136 so that the motion controller 136 can execute the target path/trajectory 259 as accurately as possible.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various components, blocks, modules, circuits, and steps have been generally described in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
obtaining, from a kinematic vehicle model, by one or more processors associated with an autonomous vehicle, one or more candidate trajectories that satisfy one or more constraints relating to movement of the vehicle;
iteratively updating, by the one or more processors, a score of each of the one or more candidate trajectories;
determining, by the one or more processors among the one or more candidate trajectories, a target trajectory having a score that is greater than a threshold; and
executing, by the one or more processors, the target trajectory to cause the vehicle to move in the candidate trajectory.

2. The method of claim 1, wherein each of the one or more candidate trajectories is a longitudinal trajectory for a predetermined duration of time.

3. The method of claim 1, wherein the predetermined duration of time is greater than or equal to 10 seconds.

4. The method of claim 1, wherein each of the one or more constraints relates to at least one of (1) distance and time, (2) velocity and time, or (3) velocity and distance.

5. The method of claim 1, wherein obtaining the one or more candidate trajectories comprises performing a differentiable simulation on a differential equation of the kinematic vehicle model.

6. The method of claim 1, wherein obtaining the one or more candidate trajectories comprises performing a first order optimization with respect to a differential equation of the kinematic vehicle model.

7. The method of claim 6, wherein the differential equation of the kinematic vehicle model relates to a control of an acceleration of the vehicle.

8. The method of claim 1, wherein iteratively updating the score of each candidate trajectory comprises updating the score of each candidate trajectory based on a reward function.

9. The method of claim 1, wherein iteratively updating the score of each candidate trajectory comprises determining the score of each candidate trajectory based on how well each candidate trajectory satisfies the one or more constraints.

10. The method of claim 1, wherein iteratively updating the score of each candidate trajectory comprises determining the score of each candidate trajectory based on how aggressively each candidate trajectory drives the vehicle.

11. A system comprising:
a non-transitory computer readable medium containing instructions that are executed by one or more processors associated with an autonomous vehicle and configured to:
obtain, from a kinematic vehicle model, one or more candidate trajectories that satisfy one or more constraints relating to movement of the vehicle;
iteratively update a score of each of the one or more candidate trajectories;
determine, among the one or more candidate trajectories, a target trajectory having a score that is greater than a threshold; and
execute the target trajectory to cause the vehicle to move in the candidate trajectory.

12. The system of claim 11, wherein each of the one or more candidate trajectories is a longitudinal trajectory for a predetermined duration of time.

13. The system of claim 11, wherein the predetermined duration of time is greater than or equal to 10 seconds.

14. The system of claim 11, wherein each of the one or more constraints relates to at least one of (1) distance and time, (2) velocity and time, or (3) velocity and distance.

15. The system of claim 11, wherein in obtaining the one or more candidate trajectories, the instructions cause the one or more processors to perform a differentiable simulation on a differential equation of the kinematic vehicle model.

16. The system of claim 11, wherein in obtaining the one or more candidate trajectories, the instructions cause the one or more processors to perform a first order optimization with respect to a differential equation of the kinematic vehicle model.

17. The system of claim 16, wherein the differential equation relates to a control of an acceleration of the vehicle.

18. The system of claim 11, wherein in iteratively updating the score of each candidate trajectory, the instructions cause the one or more processors to update the score of each candidate trajectory based on a reward function.

19. The system of claim 11, wherein in iteratively updating the score of each candidate trajectory, the instructions cause the one or more processors to determine the score of each candidate trajectory based on how well each candidate trajectory satisfies the one or more constraints.

20. The system of claim 11, wherein in iteratively updating the score of each candidate trajectory, the instructions cause the one or more processors to determine the score of each candidate trajectory based on how aggressively each candidate trajectory drives the vehicle.
